(19) United States
(12) Patent Application Publication
(10) Pub. No.: US 2010/0116118 A1
(43) Pub. Date: May 13, 2010

(54) Multi-Plane Hole Punch

(76) Inventor: Frederick J. Sandor, SR., Satellite Beach, FL (US)

Correspondence Address: MAYBACK & HOFFMAN, P.A., 5722 S. FLAMINGO ROAD #232, FORT LAUDERDALE, FL, 33330, US

(21) Appl. No.: 12/266,645

(22) Filed: Nov. 7, 2008

(51) Int. Cl. B26F 1/14

(52) U.S. Cl. 83/686

(57) ABSTRACT

A hole punch includes a body having a punching end and a longitudinal extent defining a longitudinal axis, where the punching end defines a punching face that has a first surface substantially perpendicular to the longitudinal axis, the first surface having a length substantially bisecting the punching face and a non-zero width, a second sloping surface with a slope starting substantially near an extent of and substantially near a plane of the first surface, sloping away from the first surface at a slope angle, and running in a direction of the length of the first surface, and a third sloping surface on a side of the first sloping surface opposite the second sloping surface and having a slope angle opposite the slope angle of the second sloping surface.

### FIELD OF THE INVENTION

The present invention relates generally to industrial hole punches, and more particularly relates to an improved punch-head featuring multiple punch surfaces that, together, significantly reduce the blunt driving force necessary for forming apertures in metallic objects.

### BACKGROUND OF THE INVENTION

In use, a punch and die are axially aligned with a metallic work piece located therebetween. The punch and die are brought closer and closer together until the punch is recessed into the die cavity. In the process, metal from the work piece is sheared by the cutting edges of the punch moving relative to a correspondingly shaped aperture of the die cavity.

Each punch has a punch face, which is the portion of the punch that actually makes contact with and pushes the metal out of the aperture in the work piece. Most industrial punch faces are simply flat surfaces having the necessary outer shape to create the desired aperture in the punched object. In terms of physics, with a flat-faced punch head, the hole is formed simply by a brute force pushing of the metal into the die. The force that is needed to push the metal out of the aperture increases exponentially as the thickness and area of the metal being punched increases. In industrial applications, punching metal with thicknesses on the magnitude of ½ of an inch and greater results in large power requirements, intense audible noise, and shaking that has detrimental effects on the lifespan of equipment and structures.

A few punch manufacturers have used punch-head designs that vary from the standard flat-faced punches. One such head, invented in 1883, is described in U.S. Pat. No. 294,991. The punch head described therein provides cutting faces inclined in mirror-opposing directions, with a “center pin” formed directly in the center. The supposed purpose of the inclined faces on the punch head is to distribute pressure and create a shearing force as the punch is forced into the metal. However, the extended leading edges of each of the inclined surfaces of the head described in the '991 patent are not supported and cannot be used on significant thicknesses of metal because they are easily distorted or dulled. Sharpening the edges is difficult or impossible to perform because the center pin does not allow the head to be moved across a sharpening blade. In addition, the punch head described in the '991 patent has a tendency to twist as it is inserted into the metal.

Therefore, a need exists to overcome the problems with the prior art as discussed above.

### SUMMARY OF THE INVENTION

Briefly, in accordance with the present invention, disclosed is a hole punch with a body having a punching end and a longitudinal extent defining a longitudinal axis, where the punching end defines a punching face that has a first surface substantially perpendicular to the longitudinal axis, the first surface having a length substantially bisecting the punching face and a non-zero width, a second sloping surface with a slope starting substantially near an extent of and substantially near a plane of the first surface, sloping away from the first surface at a slope angle, and running in a direction of the length of the first surface, and a third sloping surface on a side of the first sloping surface opposite the second sloping surface and having a slope angle opposite the slope angle of the second sloping surface.

In accordance with another feature of the present invention, the slope of the third sloping surface starts substantially near an extent of and substantially near the plane of the first surface, slopes away from the first surface at the slope angle, and runs in a direction of the length of the first surface.

In accordance with a further feature of the present invention, the slope of the second sloping surface intersects the slope of the third sloping surface at an intersection point.

In accordance with yet another feature of the present invention, an imaginary line parallel to the plane of the first surface and perpendicularly intersecting the length of the first surface is parallel to an imaginary line connecting the second sloping surface to the third sloping surface at the intersection point.

In accordance with an additional feature of the present invention, the imaginary line connecting the second sloping surface to the third sloping surface at the intersection point is substantially directly below a center line of the first surface.

In accordance with another feature, an embodiment of the present invention also includes a punch body of a metallic material sufficient to withstand at least 60 pounds of compressive force, the body having a longitudinal extent defining a longitudinal axis, a base end at which the compressive force is applied to the body, the base end having a securing device shaped to releasably attach the body at least to the punch press, and a punch end opposite the base end with respect to the longitudinal axis, the punch end having a distal end surface with at least three surface portions. A first of the surface portions extends in a plane substantially orthogonal to the longitudinal axis, a second of the surface portions extends in a plane at an angle to the longitudinal axis, and a third of the surface portions extends in a plane at an angle to the longitudinal axis reverse-mirror opposite the second surface portion.

The present invention, according to various embodiments, provides several advantages over the prior art, such as, requiring less punching force, requiring less electricity to drive the machine using the punch, reducing wear on all parts, reducing the cost of maintenance, reducing noise, reducing shockwaves, and many more.

### BRIEF DESCRIPTION OF THE DRAWINGS

The accompanying figures, where like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a plan view of a hole punch in accordance with the present invention;

FIG. 2 is a side elevational and hidden view of the hole punch of FIG. 1 in accordance with the present invention;

FIG. 3 is a fragmentary side elevational and hidden view of the hole punch of FIG. 2 in accordance with the present invention;

FIG. 4 is a perspective view of the hole punch of FIG. 2 in accordance with the present invention;

FIG. 5 is a partially cross-sectional and fragmentary side elevational view of the hole punch of FIG. 2 axially aligned with a die in accordance with the present invention;

FIG. 6 is a partially cross-sectional, partially hidden, and side elevational view of the hole punch of FIG. 2 held in a sharpening fixture in accordance with the present invention; and

FIGS. 7-10 are plan views of different punch face shapes in accordance with the present invention.

In the following, the invention will be described in more detail by exemplary embodiments and the corresponding figures. The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention. These schematic illustrations are not true to scale.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The present invention provides a hole punch with a multi-faceted punch face that distributes shearing forces across a punch load, thereby drastically reducing the force needed to remove material from an aperture in a work piece.

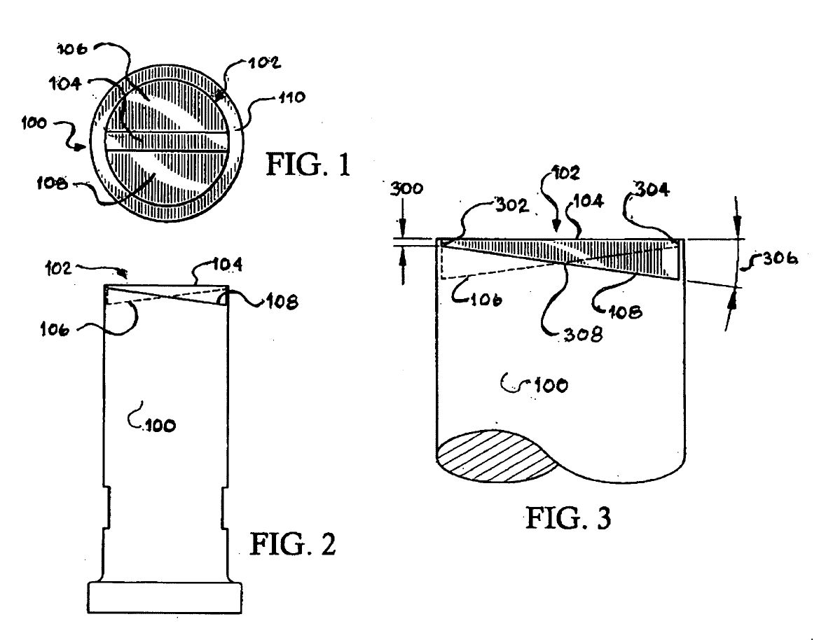

Referring now to FIG. 1, the inventive hole punch 100 is shown in a top planar view. In this view, the face 102 of the punch 100 is easily seen and includes three main sections: a central flat planar section 104, a first sloping surface 106 immediately adjacent the flat surface 104, and a second sloping surface 108, also immediately adjacent the flat surface 104, but on a side opposite the first sloping surface 106 and with a slope angle mirror-opposite the slope angle of first sloping surface 106 as viewed in FIG. 3. When viewed from the face 102 (i.e., a plan view), the orientation of the opposing surfaces 106 and 108 can be referred to as reverse-mirror opposite, in that one of these surfaces is 180-degrees opposite to an expected orientation of the surface when a mirror is disposed therebetween. The opposing slope angles are better seen in the following figures.

FIGS. 2 and 3 are side elevational views of the hole punch 100 and provide a clear illustration of the slopes of the three surfaces 104, 106, and 108, as well as their relationship to each other. In the particular embodiment shown, the flat planar section 104 is elevated slightly above the two sloped surfaces 106 and 108. This elevation, however, is not required and is not present in other embodiments. FIG. 3, in particular, shows a dimension 300, which corresponds to a difference in height between the flat planar section 104 and a leading edge 302 of the second sloping surface 108. When the dimension 300 is non-zero, the flat planar section 104 makes contact with the work piece before the leading edge 302 of the second sloping surface 108. The downward slope of the second sloping surface 108 results in an angle 306 between a plane of the flat planar section 104 and a plane of the second sloping surface 108. The load then transfers along the length of the second sloping surface 108, pushing the material out of the way a little at a time.

Shown by hidden lines in FIGS. 2 and 3 is the first sloping surface 106 on a side of the flat planar section 104 opposite the second sloping surface 108 and sloping in a direction mirror-opposite to the slope direction of the second sloping surface 108. A leading edge 304 of the first sloping surface 106, according to the embodiment shown in FIGS. 2 and 3, is also at a distance 300 below the surface of the flat planar section 104. The distance 300 is not necessary, however, and can be zero in certain embodiments.

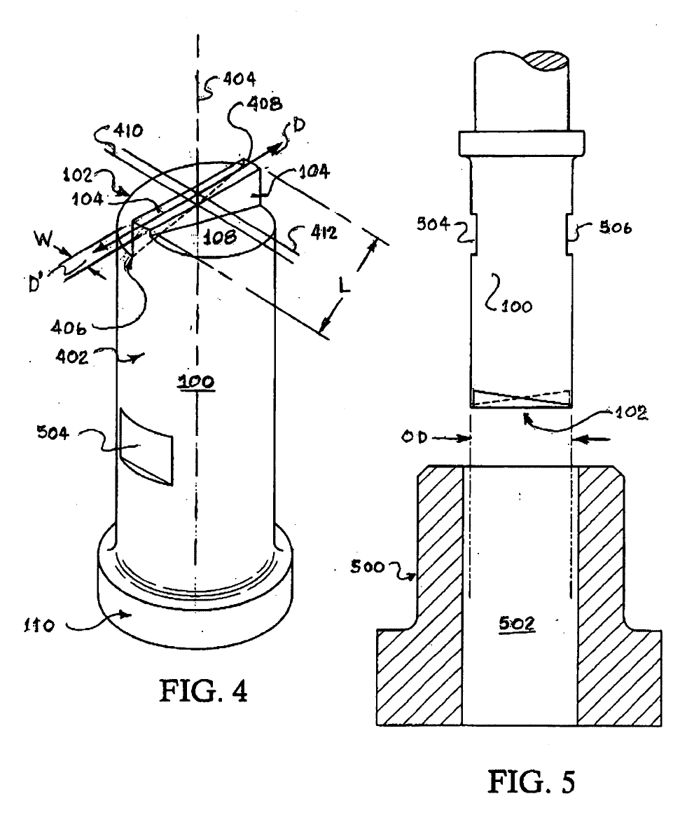

Additionally, as with the second sloping surface 108, the downward slope of the first sloping surface 106 results in an angle substantially the same as angle 306, between a plane of the flat planar section 104 and a plane of the first sloping surface 106. The term “substantially,” as used herein, is intended to indicate something that is largely but not necessarily wholly that which is specified. When the slope angles are the same, the slope of the first sloping surface intersects the slope of the second sloping surface at an intersection point 308 when viewed from the elevational view of FIG. 3. The intersection point 308, when viewed in the perspective view of FIG. 4, becomes an imaginary line 410 that connects the first sloping surface 106 to the second sloping surface 108. The imaginary line 410 is parallel to a second imaginary centerline 412 that runs through the plane of the first surface 104 and perpendicularly intersects the length L of the first surface 104.

In some embodiments, the slopes of surfaces 106 and 108 angle slightly outward and away from each other. In these embodiments, the imaginary line 410 will only make contact With the surfaces 106, 108 at a single point on the inside edge of each (the edges touching the sidewalls of the first surface 104) and will not rest on the entire plane of the surfaces 106, 108, as does line 410.

Continuing to focus on FIG. 4, a perspective view of the hole punch 100 is shown, where the inventive features can be seen with specificity. In particular, the view of FIG. 4 shows a body 402 that has a punching end 406 and a longitudinal extent defining a longitudinal axis 404. The punching end 406 defines the punching face 102, with the first surface 104 substantially perpendicular to the longitudinal axis 404. The first surface 104 has a length L that substantially bisects the punching face 102. The first surface also has a non-zero width W, giving it a rectangular shape in the embodiments shown.

The first sloping surface 106 has a slope starting at an extent 408 of and substantially near the plane of the first surface 104. The sloping surface 106 slopes away from the first surface 104 at a slope angle mirror-opposite to 306 (shown in FIG. 3) and runs in a general direction D-D′ of the length L of the first surface 104, although not in the same plane. The general direction D-D′ is shown in FIG. 4 as a double headed arrow. The arrow indicates that D is one direction and D′ is a opposite to D, but in the same plane. Put in another way, the term “runs in a general direction D of the length L of the first surface 104,” as used herein, is intended to mean that if the angle of the slope of the sloped surfaces 106 and 108 was reduced to zero, the planes of all three surfaces would be parallel with each other. The second sloping surface 108 is shows on a side of the first surface 104 mirror-opposite the first sloping surface 106 and has a slope angle 306 (shown in FIG. 3) mirror-opposite to the slope angle of the first sloping surface 106.

A flange 110 is provided at a point along the body 402 of the hole punch 100 a distance away from the punching end 406. The flange 110 is used to apply force to the punch 100 and move it toward the work piece with sufficient pressure to form an aperture in the work piece. Any force applied to the flange 110 is transferred through the punch body 402 to the punch face 102.

Referring now to FIG. 5, a die 500 is shown. The die 500 has a cavity 502 with a shape that substantially corresponds to a shape of the punch 100, but is slightly larger than an outer dimension OD of the shape of the punch 100. The die cavity 502 is positioned under a work piece axially aligned with the punch 100 prior to punching. Once the work piece is in place, i.e., placed between the punch 100 and the die 500, the punch 100 is pressed toward the die cavity 502, through the work piece, and ultimately into the die cavity 502. In the process, a portion of the work piece is sheared by the punch 100.

Through use of the punch head shape, and slight variations thereof, in accordance with embodiments of the present invention, the force needed to punch apertures in metallic work pieces, e.g. ¼ to 1″ thick, is reduced by approximately half of that needed to punch apertures in the same thickness material using prior-art flat punch heads. In addition, the noise factor is reduced by as much as 90%, providing significant improvements to the working environment around the punch machines and reducing or even eliminating the risk of damage to worker's hearing.

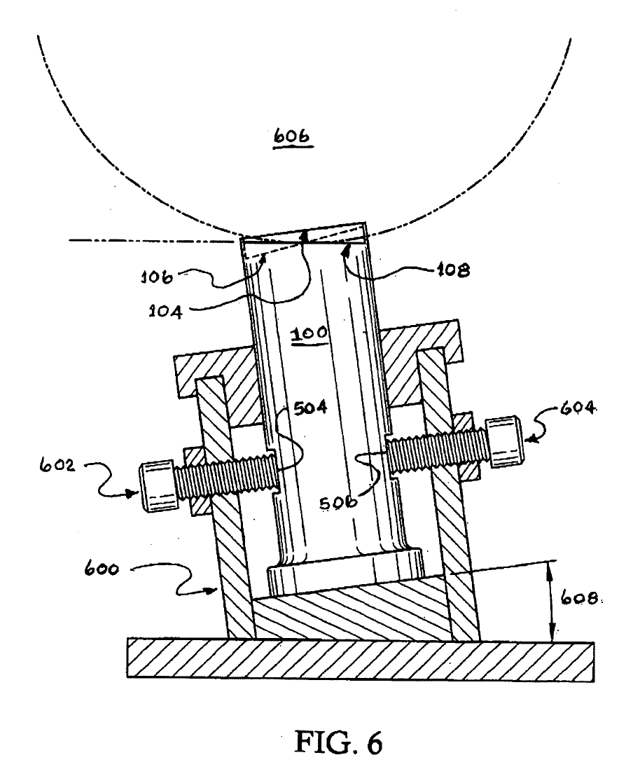

Advantageously, the present invention is easily maintained for continued effective aperture punching. Due to the large forces that the punch face 102 is exposed to, some degradation of the surfaces 104, 106, 108 will naturally result over time. As a result, the surfaces 104, 106, 108 may require some regular sharpening or maintenance to place them back into proper condition. FIGS. 4 and 5 show an opposing set of exemplary indentions 504 and 506 provided on a location along the body 402. The indentions 504, 506, as shown in FIG. 6, can be used for holding the punch 100 when sharpening the edges 104, 106, and 108 of the punching face 102, as will now be described.

Referring now to FIG. 6, the punch 100 is held in a sharpening fixture 600 by a pair of opposing members 602 and 604 that clamp onto the punch 100 by making securing contact with the opposing indentions 504 and 506, respectively. Once secured to the fixture 600, a sharpening blade 606 (diagrammatically shown with a double-dot-dashed line) is brought into contact with the edges 104, 106, 108. The sharpening blade 606 can be a sharpening stone or any other material that is suitable for grinding the material of the punch, e.g., metal.

In the embodiment shown, the fixture 600 secures the punch 100 at an angle 608, which is the same angle as the slope angle 306 of the first and second sloped faces 106 and 108. When the fixture 600 is moved relative to the fixed sharpening blade 606, the surfaces are sharpened and retain the same slope. When utilizing a fixture such as fixture 600, the punch 100 is sharpened in one direction and then turned and sharpened in another direction. More specifically, the punch 100, after passing under the sharpening blade 606 (or the blade being passed over the punch 100), the punch 100 can be released from between the opposing member 602 and 604 and turned 180 degrees so that member 602 makes contact with indention 506 and opposing member 604 makes contact with indention 504. The fixture can then again be moved relative to the fixed sharpening blade 606 to sharpen the surfaces.

Punches sharpened with the sharpening fixture 600 stay sharp longer and are less prone to damage since the load forces at the punch edges are significantly reduced due to the shearing action that takes place during a typical punch. The punch displaces the material a little at a time rather than all at once, which significantly reduces the trauma inflicted by the prior-art flat-faced punches to both the machinery and the punch assembly.

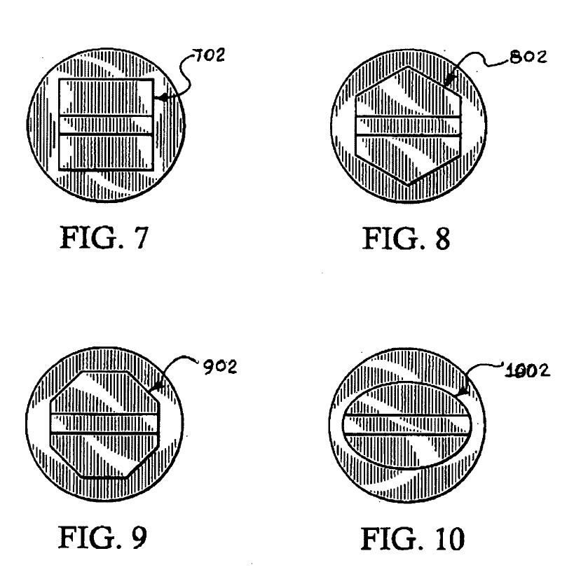

As an additional feature, the shape of the punch head 102 can be provided in a plurality of different shapes, each of which can be used to create corresponding aperture shapes in work pieces. FIGS. 7-10 provide some exemplary punch head shapes. For instance, punch head 702 in FIG. 7 is square, punch head 802 in FIG. 8 is hexagonal, punch head 902 in FIG. 9 is octagonal, and punch head 1002 in FIG. 10 is ovular. These exemplary shapes are in no way exhaustive of the possible punch-head shapes provided with embodiments of the present invention.

An improved hole punch has been disclosed that features multiple surfaces with varying slopes, which serve to drastically reduce the force needed to create apertures in metallic and other work pieces, as well as reduce the sound made at the time of impact between the punch and the work piece. Less force results in an ability to use smaller sized equipment, which eliminates the need to purchase expensive larger machinery for the facility. In short, the present invention's dramatic improvement over prior-art punches results in a dramatic reduction in trauma to the work piece, the punch, and to all other equipment driving the punch.

What is claimed is:

1. A hole punch comprising:
a body having a punching end and a longitudinal extent defining a longitudinal axis, the punching end defining a punching face, the punching face having:
a first surface substantially perpendicular to the longitudinal axis, the first surface having a length substantially bisecting the punching face and a non-zero width;
a second sloping surface with a slope starting substantially near an extent of and substantially near a plane of the first surface, sloping away from the first surface at a slope angle, and running in a direction of the length of the first surface; and
a third sloping surface on a side of the first sloping surface opposite the second sloping surface and having a slope angle opposite the slope angle of the second sloping surface.

2. The hole punch according to claim 1, wherein:
the slope of the third sloping surface starts substantially near an extent of and substantially near the plane of the first surface, slopes away from the first surface at the slope angle, and runs in a direction of the length of the first surface.

3. The hole punch according to claim 1, wherein:
the slope of the second sloping surface intersects the slope of the third sloping surface at an intersection point.

4. The hole punch according to claim 3, wherein:
an imaginary line parallel to the plane of the first surface and perpendicularly intersecting the length of the first surface is parallel to an imaginary line connecting the second sloping surface to the third sloping surface at the intersection point.

5. The hole punch according to claim 4, wherein:
the imaginary line connecting the second sloping surface to the third sloping surface at the intersection point is substantially directly below a center line of the first surface.

6. The hole punch according to claim 1, wherein:
the slope angle of the second surface is between about 5 to 25 degrees from the plane of the first surface.

7. A hole punch for a punch press, comprising:
a punch body of a metallic material sufficient to withstand at least 60 pounds of compressive force, the body having:
a longitudinal extent defining a longitudinal axis;
a base end at which the compressive force is applied to the body, the base end having a securing device shaped to releasably attach the body at least to the punch press; and
a punch end opposite the base end with respect to the longitudinal axis, the punch end having a distal end surface with at least three surface portions:
a first of the surface portions extending in a plane substantially orthogonal to the longitudinal axis;
a second of the surface portions extending in a plane at an angle to the longitudinal axis; and
a third of the surface portions extending in a plane at an angle to the longitudinal axis reverse-mirror opposite the second surface portion.

8. The punch according to claim 7, wherein the first surface portion is substantially flat.

9. The punch according to claim 7, wherein the second and third surface portions are substantially flat.

10. The punch according to claim 7, wherein the second and third surface portions are on opposing sides of the first surface portion.

11. The punch according to claim 7, wherein the second surface portion extends in a plane at an angle to the first surface portion and to the third surface portion.

12. The punch according to claim 7, wherein the third surface portion extends in a plane at an angle to the first surface portion and to the second surface portion.

13. The punch according to claim 7, wherein the securing device is shaped to releasably attach the body at least to a sharpening device.

14. The punch according to claim 8, wherein:
the second surface portion has first and second opposing second outer ends at a distance from the first surface portion in a direction toward the base end; and the third surface portion has first and second opposing third outer ends at a distance from the first surface portion in the direction toward the base end.

15. The punch according to claim 8, wherein:
the first surface portion has first and second opposing first outer ends;
the second surface portion has first and second opposing second outer ends and the first opposing second outer end is disposed at a distance from the first opposing first outer end in a direction of the longitudinal axis towards the base end; and
the third surface portion has first and second opposing third outer ends and the first opposing third outer end is disposed at a distance from the second opposing first outer end in the direction of the longitudinal axis towards the base end.
